(19) United States
(12) Patent Application Publication
(10) Pub. No.: US 2011/0181432 A1
(43) Pub. Date: Jul. 28, 2011

(54) EXTERNAL DEVICE HAVING LOW POWER DETECTION AND PROTECTION AND METHOD THEREOF

(76) Inventors: Ming-Chang Ou, Taipei City (TW); Din-Ji Tzou, Taipei City (TW); Chih-Heng Chiu, Taipei City (TW); Chung-Won Shu, Taipei City (TW)

(21) Appl. No.: 12/729,248

(22) Filed: Mar. 23, 2010

(30) Foreign Application Priority Data
Jan. 26, 2010 (TW) 099102071

(51) Int. Cl. G08B 21/00; G06F 13/36

(52) U.S. Cl. 340/664; 710/313

(57) ABSTRACT

When an external device connects to a connecting port of a host, a current detection circuit of the external device detects if the current provided by the host is less than the working current needed by the external device. If the current provided by the host is insufficient to initialize and operate the external device, a controller of the external device then stop powering the main component of the external device so that the main component will not damage due to constantly start/stop and can be protected. Meanwhile, an indicator of the external device notifies the insufficiency of current provision by vibrating, beeping, or displaying an indicating signal. Illusion of failure of the external device may be effectively avoided.

### BACKGROUND OF THE INVENTION

1. Field of the Invention

The invention relates to an external device and detection/protection method, and more particularly, to an external device having lower power detection and protection and method thereof.

2. Description of the Prior Art

External devices have been advancing as mature applications for computer peripherals from mouse, keyboards, and joysticks to scanners, digital cameras, printers, hard disk drives (HDD), optical disk drives, and network devices, with support of hot plug and play further simplifying connection to a host.

External devices with common universal serial bus (USB) 2.0 standard use 5V and 500 mA to connect to the host. New generation USB 3.0 maximizes the supply current from the host up to the 900 mA. However, for external devices with very large power consumption such as the hard disk drives and the optical disk drives, the current needed for the devices is usually far exceeding the maximum current that can be provided by the connection port, for example, the USB interface, or IEEE 1394, eSATA interfaces when connecting to the host. Please refer to FIG. 1. FIG. 1 is a schematic diagram of a flow chart showing initialization steps 100 when an external device connects to a host. The steps are as follows:

Step 102: The external device plugs into the connection port of the host;

Step 104: The host detects load of the connection port and starts to provide current for the external device;

Step 106: Is the current provided by the host enough for the initialization of a main component of the external device (such as the disk in HDD or the driving motor in optical disk drive)? If yes, then proceed Step 110; if no, then proceed Step 108;

Step 108: The controller waits for completion of initialization of the main component;

Step 110: Proceed following connection handshaking of the external device and the host.

When the external device is undergoing the initialization, if the current provided by the host is not enough for the external device, the external device may go through being powered on and off alternately, which damages the components of the external device.

Additionally, the external devices may likely experience low power fault during operation phase. The external HDD or optical disk drive usually needs more current than the connection port can provide to perform read/write process. Too long connection line between the external device and the host also leads to insufficient current supplied.

On the other hand, failure of initializing the external device or occasional break down during normal operation due to insufficient supply current causes illusion of malfunction of the device.

### SUMMARY OF THE INVENTION

The invention provides a method for detecting input current of an external device and protecting the external device. The method includes following steps: detecting if a supply current provided by a host is less than a working current needed by the external device when the external device connects to the host; a controller of the external device stopping powering a main component of the external device when the supply current from the host is less than the working current needed by the external device; and the controller controlling an indicator of the external device to generate an indicating signal.

The invention also provides an external device having lower power detection and protection. The external device includes a detection circuit for detecting if a supply current provided by a host is less than a working current needed by the external device when the external device connects to the host, a main component, a controller connecting to the detection circuit and the main component for stopping powering the main component when the supply current is less than the working current needed by the external device, and an indicator connecting to the controller for generating an indicating signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a flow chart showing initialization steps when an external device connects to a host.

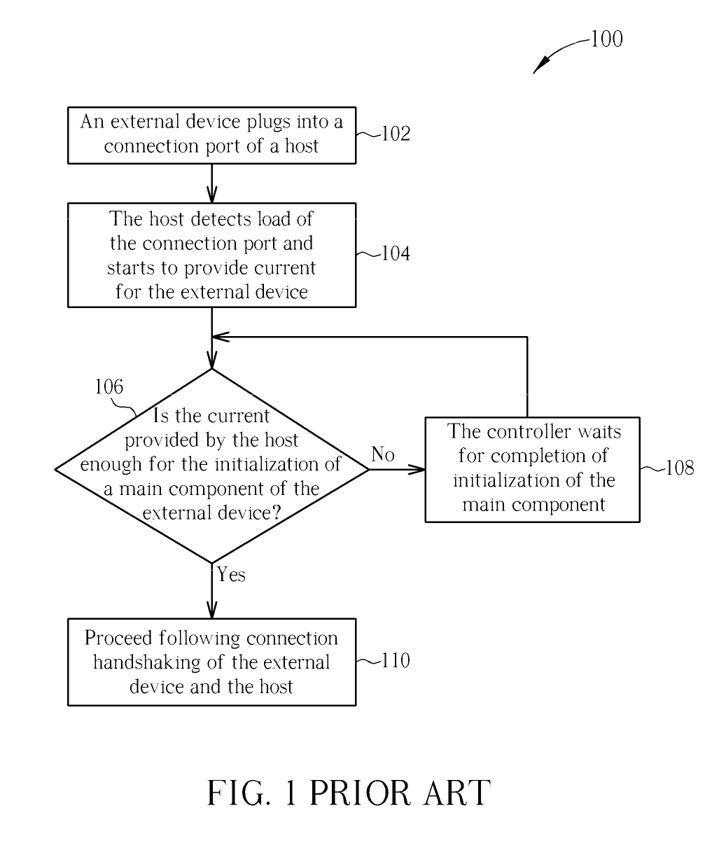

FIG. 2 is a schematic diagram illustrating a flow chart of input current detection and protection method for an external device disclosed in the invention.

FIG. 3 shows a block diagram of an external device connecting to a host using the method in FIG. 2.

FIG. 4 shows another embodiment of the external device connecting to the host.

### DETAILED DESCRIPTION

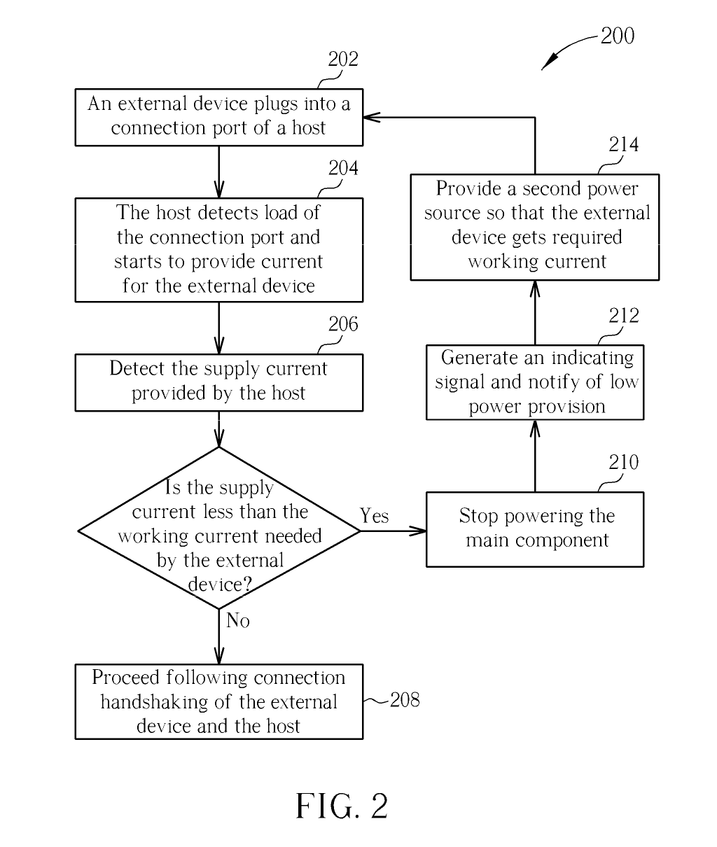

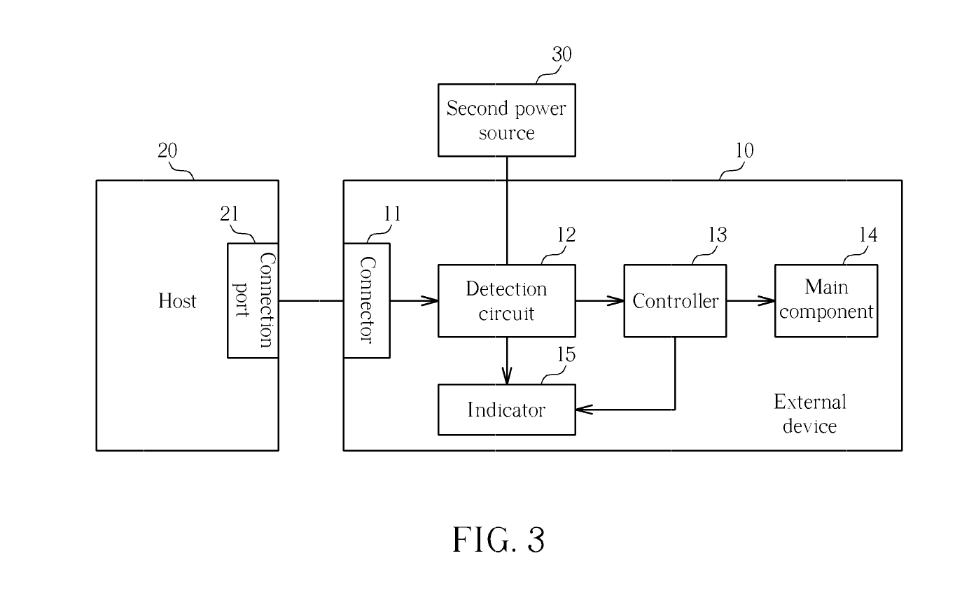

Please refer to FIG. 2 and FIG. 3, where FIG. 2 is a schematic diagram illustrating a flow chart of input current detection and protection method for an external device 10 disclosed in the invention, and FIG. 3 shows a block diagram of the external device 10 connecting to a host 20, which uses the method in FIG. 2. The external device 10 can be an external hard disk drive, an external optical disk drive, a hub, a pen drive, or a 3G communications device. The external device 10 includes a connector 11, a detection circuit 12, a controller 13, a main component 14, and an indicator 15. The external device 10 connects to the host 20 by use of a connector 11 plugging to a connection port 21 of the host 20. The connector 11 of the external device 10 may be of the universal serial bus (USB), the IEEE 1394, or the eSATA standard, and the connection port 21 of the host 20 is a port of the same standard as the connector 11. The detection circuit 12 is connecting between the connector 11 and the controller 13. The controller 13 further connects to the main component 14 of the external device 10. Taking an external hard disk drive or an external optical disk drive as the example of the external device 10, the main component 14 means the hard disk in the HDD or the driving motor in the optical disk drive. When discussing about a pen drive, the main component 14 means the flash chip. The main component 14 is operated by the controller 13 that powers the main component 14 and gives instructions. The indicator 15 connects to the controller 13 (or the detection circuit 12) and can be realized as a light emitting diode (LED), a liquid crystal display (LCD), an e-paper, a beeper, a speaker, or a vibrator, for being controlled by the controller 13 or the detection circuit 12 to generate an indicating signal that notifies an user of low current issue.

FIG. 2 shows the method for detecting if a supply current from the host 20 is enough for initializing the external device 10 and keeping the external device 10 work, and for protecting the external device 10 when the supply current is not enough. The connection of the external device 10 to the host 20 means either the initialization phase or the following working connection phase. The method has the following steps:

Step 202: the external device 10 plugs into the connection port 21 of the host 20, for the initialization phase only.

Step 204: the host 20 detects load of the connection port 21 due to the plug-in of the external device 10 and starts to provide current for the external device 10.

Step 206: the detection circuit 12 of the external device 10 detects if the supply current provided by the host 20 is less than the working current needed by the external device 10. If the supply current is not less than the working current required, the host 20 is providing enough current for operating the external device 10 and Step 208 is then proceeded.

Step 208: continue to proceed following connection handshaking of the external device 10 and the host 20, and a normal connection between the external device 10 and the host 20 is then established.

For example, when the host 20 detects the load of connection port 21 to provide current for the external device 10 accordingly, the host 20 also sends a connection require signal, or a handshake signal like the “USB identify” to all of its connection ports 21. The controller 13 of the external device 10 then sends an acknowledging signal to the host 20 and the connection between the external device 10 and the host 20 is established. The external device 10 sends different signal back to the host 20 according to its speed level (such as the speed levels USB super/high/full/low speed for a USB device) and informs the host 20 of the device class. When the host 20 receives the signal sent back from the external device 10, it tells the external device 10 the speed level of the connection port 21 for the external device 10 to self-adjust the speed level accordingly. The connection port 21 of the host 20 and the external device 10 set up a same speed level connection according to the slower one of the speed levels of the two.

During the handshaking of the connection establishment, the host 20 may also assign an I/O address or part of memory area of the host 20 to the external device 10, or install a driver of the external device 10, so that the external device 10 is ready to use.

When the supply current detected by the detection circuit 12 in Step 206 is less than the required working current of the external device 10, the external device 10 can not be initialized by the host 20. Step 210 is then carried out.

Step 210: The controller 13 of the external device 10 cuts off the main component 14 and also stops powering the main component 14 to prevent repetitive start/stop of the main component 14 caused by insufficient current, which may damage the main component or reduce the life of the main component.

Step 212: Even though the insufficient current from the host 20 leads to the suspension of the main component 14 in Step 210, the controller 13 or the detection circuit 12 of the external device 10 may still perform some functions by use of the supply current of the host 20. In this step, the controller 13 or the detection circuit 12 controls the indicator 15 to generate the indicating signal by lighting, showing message, making sound, or vibrating and notify the user of the low power provision of the host 20.

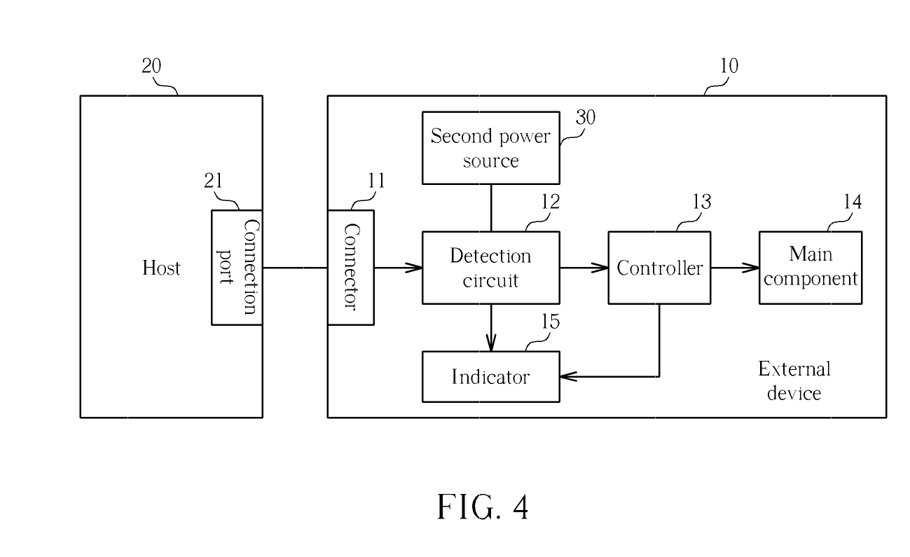

Step 214: An additional power supply, such as an adaptor with Y-cable, may further connect to the external device 10 or the external device 10 may uses its built-in power source, as shown in another embodiment in FIG. 4, to serve as a second power source 30 to the external device 10. The built-in power source in the external device 10 automatically provides power once the detection circuit 12 detects low current from the host 20. The external device 10 may also switch to the host 20 as the power source after the provision of current from the host 20 becomes steady, which is detected by the detection circuit 12. Since the provided current of the second power source 30 is greater than the required working current of the external device 10, the external device 10 is allowed to initialize. After the external device 10 is replugged to the connection port 21 (Step 202), the controller 13 powers the main component 14 by use of the second power source 30. The following Steps (Step 204, Step 206, and Step 208) are performed.

The external device disclosed in the embodiments of the invention utilizes the current detection circuit to detect if the supply current provided by the host is less than the working current needed by the external device when the external device connects to the connecting port of the host. If the supply current provided by the host is insufficient to initialize and operate the external device, the controller of the external device then stop powering the main component of the external device so that the main component will not damage due to constantly start/stop and can be protected. Meanwhile, an indicator of the external device notifies the insufficiency of current provision by vibrating, beeping, or displaying an indicating signal to a user. Illusion of failure of the external device may be effectively avoided and the external device can be normally initialized and in operation after a sufficient power supply is provided.

Those skilled in the art will readily observe that numerous modifications and alterations of the device and method may be made while retaining the teachings of the invention.

What is claimed is:

1. A method for detecting input current of an external device and protecting the
external device, comprising following steps:
detecting if a supply current provided by a host is less than a working current needed by the external device when the external device connects to the host;
a controller of the external device stopping powering a main component of the external device when the supply current from the host is less than the working current needed by the external device; and
the controller controlling an indicator of the external device to generate an indicating signal.

2. The method of claim 1, further comprising step: the host detecting the load of the external device and supplying current for the external device when the external device initially connects to the host.

3. The method of claim 1, wherein detecting if the supply current provided by the host is less than the working current needed by the external device is carried out when the external device initially connects to the host.

4. The method of claim 1, wherein detecting if the supply current provided by the host is less than the working current needed by the external device is by utilizing a detection circuit of the external device to detect the supply current of the host.

5. The method of claim 1, further comprising step: when the supply current is not less than the working current needed by the external device, or when a second power source supplies current for the external device, the controller powering the main component and initializing the main component.

6. The method of claim 5, wherein the controller initializing the main component comprising steps:
the host and the controller sending signals to each other to establish a connection based on a same speed; and
the host assigning an I/O address or a memory area for the external device and installing a driver of the external device.

7. An external device having lower power detection and protection, comprising:
a detection circuit for detecting if a supply current provided by a host is less than a working current needed by the external device when the external device connects to the host;
a main component;
a controller connecting to the detection circuit and the main component for stopping powering the main component when the supply current is less than the working current; and
an indicator connecting to the controller for generating an indicating signal.

8. The external device of claim 7, wherein the controller is further utilized for powering the main component and initializing the main component when the supply current is not less than the working current needed by the external device or when a second power source supplies current for the external device.

9. The external device of claim 7, wherein the detection circuit is utilized for detecting if the supply current provided by a host is less than the working current needed by the external device when the external device initially connects to the host.

10. The external device of claim 7, further comprising a connector connecting to the detection circuit, the external device connecting to the host via the connector plugging to a connection port of the host.

11. The external device of claim 10, wherein the connector is of the universal serial bus (USB), the IEEE 1394, or the eSATA standard, and the connection port of the host is a port of the same standard as the connector.

12. The external device of claim 7, wherein the external device is an external hard disk drive (HDD), an external optical disk drive, a hub, a pen drive, or an 3G communications device.

13. The external device of claim 7, wherein the indicator is a light emitting diode (LED), a liquid crystal display (LCD), an e-paper, a beeper, a speaker, or a vibrator.
